(19) United States
(12) Patent Application Publication
(10) Pub. No.: US 2026/0211730 A1
(43) Pub. Date: Jul. 23, 2026

(54) APPARATUS FOR PROCESSING V2X MESSAGE

(71) Applicant: SAESOL TECH Inc., Anyang-si (KR)

(72) Inventors: Jaewoo JANG, Uiwang-si (KR); JunHyouk HAN, Hwaseong-si (KR); Junwoo KIM, Anyang-si (KR)

(73) Assignee: SAESOL TECH Inc., Anyang-si (KR)

(21) Appl. No.: 19/032,460

(22) Filed: Jan. 21, 2025

(51) Int. Cl. G06F 9/50

(52) U.S. Cl. CPC G06F 9/5027

(57) ABSTRACT

Provided is a device for processing a vehicle-to-everything (V2X) message. The device splits transmission and reception V2X message processing tasks into tasks requiring hardware acceleration and tasks not requiring hardware acceleration to perform the transmission and reception V2X message processing tasks and serializes the tasks requiring hardware acceleration such that the tasks requiring hardware acceleration are not simultaneously performed by multiple threads.

### BACKGROUND

### 1. Field

The following description relates to a vehicle-to-everything (V2X) technology, and more particularly, to a device for processing V2X messages at a high speed using a hardware acceleration chip.

### 2. Description of Related Art

Vehicle-to-everything (V2X) is a communication technology for exchanging various information including traffic-related information with infrastructure, a personal terminal, or the like installed in another vehicle, a road, or the like via a wired and/or wireless network. V2X is a concept encompassing all forms of communication that is applicable to vehicles traveling on roads, including vehicle-to-vehicle (V2V) communication, vehicle-to-infrastructure (V2I) communication, vehicle-to-pedestrian (V2P) communication, and the like.

Especially with the growing interest in autonomous driving, it is necessary to provide such V2X communication more effectively. Particularly in traffic congestion, each individual vehicle may be required to process V2X messages thousands of times per second or more. It is necessary to process V2X message conformance, signature verification, and the like at a high speed. Particularly, elliptic curve digital signature algorithm (ECDSA) signature verification cryptography computation employs a hardware-dedicated acceleration chip for fast processing, and thus it is necessary to efficiently process other functions together with the ECDSA in parallel.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

The following description relates to providing a device for minimizing the idle time of a processor by serializing and processing, in strands, a function that is used for processing vehicle-to-everything (V2X) messages through multiple threads and requires hardware-dedicated acceleration.

Technical objects to be achieved in the present invention are not limited to that described above, and other technical objects that have not been described will be clearly understood by those of ordinary skill in the art from the following description.

In one general aspect, a device for processing V2X messages including at least one multi-core processor, the device including a first hardware accelerator, a thread pool manager, a first strand task controller, and a task distributor.

The first hardware accelerator sequentially performs first hardware acceleration tasks input into a first input queue and outputs task results to a first output queue.

The thread pool manager manages n threads as a thread pool and assigns tasks in a task queue to task-waiting threads to execute the threads in parallel.

The first strand task controller requests task processing from the thread pool manager such that first hardware acceleration tasks input into a first strand task queue may be executed not simultaneously but in sequence.

The task distributor includes a reception message task distributor, and the reception message task distributor splits a V2X message processing task into a first processor task and a first hardware acceleration task, inputs the first processor task into the task queue of the thread pool manager, and inputs the first hardware acceleration task split from the same V2X message processing task into the first strand task queue when the first processor task is completed.

The device may further include a second hardware accelerator and a second strand task controller, and the task distributor may further include a transmission message task distributor.

The second hardware accelerator may sequentially execute second hardware acceleration tasks input into a second input queue and outputs task results to a second output queue.

The second strand task controller may request task processing from the thread pool manager such that the second hardware acceleration tasks input into a second strand task queue may be executed not simultaneously but in sequence.

The transmission message task distributor may split a V2X message generation task into a second hardware acceleration task and a second processor task, input the second hardware acceleration task into the second strand task queue, and input the second processor task split from the same V2X message generation task into the task queue of the thread pool manager when the second hardware acceleration task is completed.

The processor of the device may be a multi-core processor, and the thread pool manager may generate a number of threads equal to the number of cores of the processor included in the device and manage the threads as the thread pool.

In another general aspect, a device for processing V2X messages may include m first hardware accelerators and accordingly include m first strand task controllers each mapped to a corresponding one of the first hardware accelerators.

The first strand task queue may have the same size as the first input queue and the first output queue of the first hardware accelerator.

Additionally, the second strand task queue may have the same size as the second input queue and the second output queue of the second hardware accelerator.

Other features and aspects will be apparent from the following detailed description, the drawings, and the claims.

### BRIEF DESCRIPTION OF THE DRAWINGS

FIG. 1 is a block diagram of a device for processing vehicle-to-everything (V2X) messages according to an aspect of the present invention.

FIG. 2 is a conceptual diagram of parallel processing through multiple threads by the device for processing V2X messages according to the aspect of the present invention.

FIG. 3 is a block diagram of a device for processing V2X messages according to another aspect of the present invention.

FIGS. 4 and 5 show examples of queue sizes of a strand task queue and an input queue and an output queue of a hardware accelerator.

Throughout the accompanying drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The above-described and additional aspects will be specified through exemplary embodiments described with reference to the accompanying drawings. It will be understood that components of each of the embodiments may be variously combined within the embodiment unless otherwise stated or contradicted. Each block of block diagrams may represent a physical part in some cases, or may be a logical representation of some functions of one physical part or a function of a plurality of physical parts in other cases. In some cases, the entity of a block or a part of the block may be a set of program instructions. All or some of these blocks may be implemented as hardware, software, or a combination thereof.

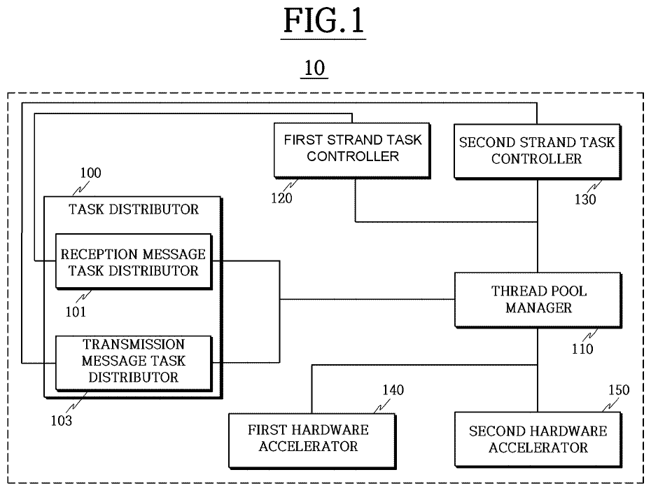

FIG. 1 is a block diagram of a device for processing vehicle-to-everything (V2X) messages according to an aspect of the present invention. A V2X message processing device 10 according to the aspect of the present invention is a device with at least one processor and includes a first hardware accelerator 140, a thread pool manager 110, a first strand task controller 120, and a task distributor 100.

The V2X message processing device 10 of the present invention is a security module on board a vehicle and performs a V2X message processing function that is used in a V2X service scenario, particularly, a function of receiving and parsing a V2X message, verifying a signature used for the conformance and security of the V2X message, performing message-based V2X service logic, and then putting a signature to generate a transmission message for the received V2X message.

A V2X message is a basic safety message (BSM) that is generally transmitted by every vehicle 10 times per second, and a BSM is a message for sending information of an ego vehicle, such as the location, the size, the orientation, the acceleration, and the like, to the vicinity. Therefore, the V2X message processing device 10 receives BSMs from all nearby vehicles, pedestrians, infrastructures, and the like and processes the BSMs.

The V2X message processing device 10 of the present invention includes at least one processor and is a device that includes a hardware acceleration chip to support multiple threads.

The V2X message processing device 10 of the present invention splits a message processing task into a processor task that is only processed on a processor, and a hardware acceleration task that is processed using the hardware acceleration chip. The hardware acceleration task may include tasks such as encryption, decryption, elliptic curve digital signature algorithm (ECDSA) signature verification, ECDSA signature, and the like.

At least some functions of the first hardware accelerator 140, the thread pool manager 110, the first strand task controller 120, and the task distributor 100 may be implemented as a set of program instructions that are executed by a processor.

The first hardware accelerator 140 includes a hardware encryption engine with a first input queue, which is an input queue, and a first output queue, which is an output queue, sequentially performs first hardware acceleration tasks, which are input into the first input queue, and outputs the task results to the first output queue. The first hardware acceleration tasks may include an ECDSA signature verification task and may be composed of a plurality of hardware acceleration task requests. In other words, the first hardware acceleration tasks which are input into the first input queue may be a plurality of hardware acceleration task requests that are made by threads, which perform first hardware acceleration tasks, to the hardware acceleration engine to process hardware acceleration tasks.

The thread pool manager 110 manages n generated threads as a thread pool and assigns a task which is input into a task queue to a task-waiting thread, parallelly executing threads. In other words, the V2X message processing device 10 of the present invention simultaneously executes tasks to be processed (a processor task and a hardware acceleration task) through n generated threads, parallelly processing the tasks to be processed.

The first strand task controller 120 requests task processing from the thread pool manager 110 such that the first hardware acceleration tasks input into a first strand task queue may be executed not simultaneously but in sequence. The first strand task controller 120 does not request task processing for another first hardware task, which is input to the first strand task queue, from the thread pool manager 110 such that a task requiring the first hardware accelerator 140 to perform hardware acceleration processing may not be simultaneously performed by threads in parallel, that is, may not be performed until the other first hardware task is completed when the other first hardware task is being performed by a thread. When a first hardware acceleration task which is currently being executed is completed, the first strand task controller 120 transmits another first hardware acceleration task which is input into the first strand task queue to the thread pool manager 110, and the thread pool manager 110 inputs the corresponding task into the task queue such that a task-waiting thread may process the task. For example, when first hardware acceleration task #1 and first hardware acceleration task #2 are successively input into the first strand task queue and no first hardware acceleration task is currently being processed, the first strand task controller 120 inputs first hardware acceleration task #1 which has been input first into the task queue through the thread pool manager 110 and assigns the task to a thread for processing. However, the first strand task controller 120 does not transmit first hardware acceleration task #2 to the thread pool manager 110 until first hardware acceleration task #1 is completed. When first hardware acceleration task #1 is completed, the first strand task controller 120 inputs first hardware acceleration task #2 into the task queue through the thread pool manager 110 and assigns the task to a thread for processing. In this way, the first strand task controller 120 prevents first hardware acceleration tasks from being simultaneously processed by threads, that is, prevents threads from simultaneously accessing the hardware acceleration chip to prevent blockage of multiple threads. In addition, when a first hardware acceleration task is in the first strand task queue and no other first hardware acceleration task is currently being processed, the first strand task controller 120 causes the first hardware acceleration task to be input into the task queue earlier than other processor tasks (a first processor task and a second processor task).

The task distributor 100 includes a reception message task distributor 101, and at least some functions of the reception message task distributor 101 may be implemented as a set of program instructions that are executed by a processor.

The reception message task distributor 101 splits a V2X message processing task for a V2X message received from an external device, such as another vehicle, a pedestrian, infrastructure, or the like, into a first processor task and a first hardware acceleration task. The reception message task distributor 101 inputs the first processor task which does not require hardware acceleration into the task queue through the thread pool manager 110 such that the first processor task may be assigned to a thread. In general, a first processor task and a first hardware acceleration task split from one V2X message processing task cannot be performed simultaneously and are to be performed in sequence. Therefore, when the first processor task is completed, the reception message task distributor 101 inputs the first hardware acceleration task which has been split from the same V2X message processing task into the first strand task queue using a callback mechanism or the like to prevent another thread from being assigned the first hardware acceleration task before the first processor task is completed and blocked until the first processor task is completed.

The V2X message processing device 10 according to the aspect of the present invention may further include a second hardware accelerator 150 and a second strand task controller 130, and the task distributor 100 may further include a transmission message task distributor 103.

At least some functions of the second hardware accelerator 150, the second strand task controller 130, and the transmission message task distributor 103 may be implemented as a set of program instructions that are executed by a processor.

The second hardware accelerator 150 includes a hardware security module (HSM) having a second input queue, which is an input queue, and a second output queue, which is an output queue. The second hardware accelerator 150 sequentially performs second hardware acceleration tasks, which are input into the second input queue, and outputs the task results to the second output queue. The second hardware acceleration tasks may include an ECDSA signature task and may be composed of a plurality of hardware acceleration task requests. In other words, the second hardware acceleration tasks which are input into the second input queue may be a plurality of hardware acceleration task requests that are made by threads, which perform second hardware acceleration tasks, to the HSM to process hardware acceleration tasks.

The second strand task controller 130 requests task processing from the thread pool manager 110 such that the second hardware acceleration tasks input into a second strand task queue may be executed not simultaneously but in sequence. The second strand task controller 130 does not request task processing for another second hardware task, which is input to the second strand task queue, from the thread pool manager 110 such that a task requiring the second hardware accelerator 150 to perform hardware acceleration processing may not be simultaneously performed by threads in parallel, that is, may not be performed until the other second hardware task is completed when the other second hardware task is being performed by a thread. When a second hardware acceleration task which is currently being executed is completed, the second strand task controller 130 transmits another second hardware acceleration task which is input into the second strand task queue to the thread pool manager 110, and the thread pool manager 110 inputs the corresponding task into the task queue such that a task-waiting thread may process the task. The second strand task controller 130 prevents second hardware acceleration tasks from being simultaneously processed by threads, that is, prevents threads from simultaneously accessing the hardware acceleration chip to prevent blockage of multiple threads. In addition, when a second hardware acceleration task is in the second strand task queue and no other second hardware acceleration task is currently being processed, the second strand task controller 130 causes the second hardware acceleration task to be input to the task queue earlier than other processor tasks (a first processor task and a second processor task).

The transmission message task distributor 103 splits a V2X message generation task into a second hardware acceleration task and a second processor task, inputs the second hardware acceleration task into the second strand task queue, and inputs the second processor task split from the same V2X message generation task into the task queue through the thread pool manager 110 when the second hardware acceleration task is completed.

The transmission message task distributor 103 splits a V2X message generation task, which is a task for processing a V2X message generated in response to a BSM generated by a vehicle equipped with the V2X message processing device 10 of the present invention or a V2X message received from an external device, into a second hardware acceleration task and a second processor task. The transmission message task distributor 103 inputs a second hardware acceleration task requiring hardware acceleration into the second strand task queue such that the second hardware acceleration task may be assigned to a thread through the thread pool manager 110. In general, a second hardware acceleration task and a second processor task split from one V2X message generation task cannot be performed simultaneously and are to be performed in sequence. Therefore, when the second processor task is completed, the transmission message task distributor 103 inputs the second processor task which has been split from the same V2X message generation task into the task queue through the thread pool manager 110 and causes the second processor task to be assigned to a thread to prevent another thread from being assigned the second processor task before the second hardware acceleration task is completed and blocked until the second hardware acceleration task is completed.

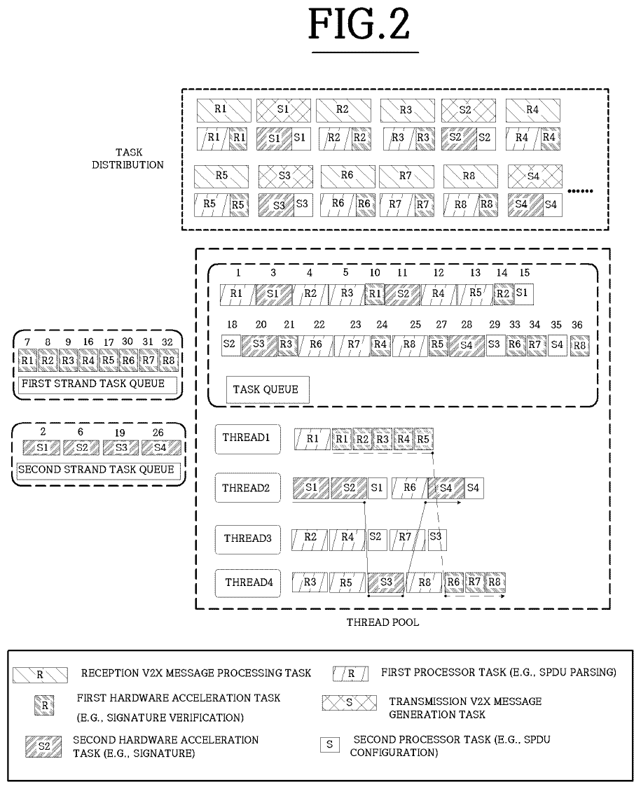

FIG. 2 is a conceptual diagram of parallel processing through multiple threads by the device for processing V2X messages according to the aspect of the present invention. The example shown in FIG. 2 shows the concept of distributing tasks R1 to R8 of processing a received V2X message and tasks S1 to S4 of generating a V2X message and processing the tasks in parallel through four threads. The turns (from 1 to 36) of tasks input into a task queue, a first strand task queue, and a second strand task queue will be described with reference to FIG. 2. In FIG. 2, there is no relation between R1 and S1. In other words, S1 is not a message generated in response to R1, and R1 and S1 only indicate the turns of a V2X reception message and a V2X transmission message, respectively.

In the example shown in FIG. 2, the V2X message processing device receives and processes V2X reception messages R1, R2, and R3 and simultaneously processes a task of generating a V2X transmission message S1.

The V2X message processing device splits a task for the received V2X reception message R1 into a first processor task R1 and a first hardware acceleration task R1 and then inputs the first processor task R1 into a task queue of a thread pool (1). Task-waiting thread 1 is assigned the first processor task R1 and processes the first processor task R1.

The V2X message processing device splits a task for the V2X generation message S1 into a second hardware acceleration task S1 and a second processor task S1 and then inputs the second hardware acceleration task S1 into the second strand task queue (2).

Since no other second hardware acceleration task is being performed, the V2X message processing device inputs the second hardware acceleration task S1 from the second strand task queue into the task queue of the thread pool (3). Task-waiting thread 2 is assigned the second hardware acceleration task S1 and processes the second hardware acceleration task S1.

The V2X message processing device splits a task for the received V2X reception message R2 into a first processor task R2 and a first hardware acceleration task R2 and then inputs the first processor task R2 into the task queue of the thread pool (4). Task-waiting thread 3 is assigned the first processor task R2 and processes the first processor task R2.

The V2X message processing device splits a task for the received V2X reception message R3 into a first processor task R3 and a first hardware acceleration task R3 and then inputs the first processor task R3 into the task queue of the thread pool (5). Task-waiting thread 4 is assigned the first processor task R3 and processes the first processor task R3.

The V2X message processing device splits a task for the V2X generation message S2 into a second hardware acceleration task S2 and a second processor task S2 and then inputs the second hardware acceleration task S2 into the second strand task queue (6). At this time, the other second hardware acceleration task S1 is being performed, and thus the V2X message processing device does not input the second hardware acceleration task S2 from the second strand task queue into the task queue of the thread pool.

When the first processor tasks R1, R2, and R3 performed by each of thread 1, thread 3, and thread 4 are completed, the V2X message processing device sequentially inputs the first hardware acceleration tasks R1, R2, and R3 into the first strand task queue (7, 8, and 9).

Since no other first hardware acceleration task is being performed, the V2X message processing device inputs the first hardware acceleration task R1 from the first strand task queue into the task queue of the thread pool (10). Task-waiting thread 1 is assigned the first hardware acceleration task R1 and processes the first hardware acceleration task R1. Here, the V2X message processing device does not input the first hardware acceleration task R2 into the task queue of the thread pool until the other hardware acceleration task R1 is completed.

When the second hardware acceleration task S1 performed by the thread 2 is completed, the V2X message processing device inputs the second hardware acceleration task S2 which has been input into the second strand task queue into the task queue of the thread pool (11). Task-waiting thread 2 is assigned the second hardware acceleration task S2 and processes the second hardware acceleration task S2.

The V2X message processing device splits a task for the received V2X reception message R4 into a first processor task R4 and a first hardware acceleration task R4 and then inputs the first processor task R4 into the task queue of the thread pool (12). Task-waiting thread 3 is assigned the first processor task R4 and processes the first processor task R4.

The V2X message processing device splits a task for the received V2X reception message R5 into a first processor task R5 and a first hardware acceleration task R5 and then inputs the first processor task R5 into the task queue of the thread pool (13). Task-waiting thread 4 is assigned the first processor task R5 and processes the first processor task R5.

When the first hardware acceleration task R1 performed by thread 1 is completed, the V2X message processing device inputs the first hardware acceleration task R2, which has been input into the first strand task queue, into the task queue of the thread pool ahead of other processor tasks (14). Task-waiting thread 1 is assigned the first processor task R2 and processes the first processor task R2.

Although the second hardware acceleration task S2 performed by thread 2 is completed, no second hardware acceleration task is left in the second strand task queue, and thus the V2X message processing device inputs the second processor task S1 into the task queue of the thread pool (15).

When the first hardware acceleration tasks R4 and R5 performed by each of thread 3 and thread 4 are completed, the V2X message processing device sequentially inputs the first hardware acceleration task R4 and R5 into the first strand task queue (16 and 17).

Although the second hardware acceleration task S2 performed by thread 2 is completed, no second hardware acceleration task is left in the second strand task queue, and thus the V2X message processing device inputs the second processor task S2 into the task queue of the thread pool (18).

The V2X message processing device splits a task for a V2X generation message S3 into a second hardware acceleration task S3 and a second processor task S3 and then inputs the second hardware acceleration task S3 into the second strand task queue (19).

Since no other second hardware acceleration task is being performed, the V2X message processing device inputs the second hardware acceleration task S3 from the second strand task queue into the task queue of the thread pool (20). Task-waiting thread 4 is assigned the second hardware acceleration task S3 and processes the second hardware acceleration task S3.

When the first hardware acceleration task R2 performed by thread 1 is completed, the V2X message processing device inputs the first hardware acceleration task R3, which has been input into the first strand task queue, into the task queue of the thread pool ahead of other processor tasks (21). Task-waiting thread 1 is assigned the first hardware acceleration task R3 and processes the first hardware acceleration task R3.

The V2X message processing device splits a task for a received V2X reception message R6 into a first processor task R6 and a first hardware acceleration task R6 and then inputs the first processor task R6 into the task queue of the thread pool (22). Task-waiting thread 2 is assigned the first processor task R6 and processes the first processor task R6.

The V2X message processing device splits a task for a received V2X reception message R7 into a first processor task R7 and a first hardware acceleration task R7 and then inputs the first processor task R7 into the task queue of the thread pool (23). Task-waiting thread 3 is assigned the first processor task R7 and processes the first processor task R7.

When the first hardware acceleration task R3 performed by thread 1 is completed, the V2X message processing device inputs the first hardware acceleration task R4, which has been input into the first strand task queue, into the task queue of the thread pool ahead of other processor tasks (24). Task-waiting thread 1 is assigned the first hardware acceleration task R4 and processes the first hardware acceleration task R4.

The V2X message processing device splits a task for a received V2X reception message R8 into a first processor task R8 and a first hardware acceleration task R8 and then inputs the first processor task R8 into the task queue of the thread pool (25). Task-waiting thread 4 is assigned the first processor task R8 and processes the first processor task R8.

The V2X message processing device splits a task for a V2X generation message S4 into a second hardware acceleration task S4 and a second processor task S4 and then inputs the second hardware acceleration task S4 into the second strand task queue (26). At this time, the other second hardware acceleration task S3 is being performed, and thus the V2X message processing device does not input the second hardware acceleration task S4 from the second strand task queue into the task queue of the thread pool.

When the first hardware acceleration task R4 performed by thread 1 is completed, the V2X message processing device inputs the first hardware acceleration task R5, which has been input into the first strand task queue, into the task queue of the thread pool ahead of other processor tasks (27). Task-waiting thread 1 is assigned the first hardware acceleration task R5 and processes the first hardware acceleration task R5.

When the second hardware acceleration task S3 performed by thread 4 is completed, the V2X message processing device inputs the second hardware acceleration task S4, which has been input into the second strand task queue, into the task queue of the thread pool ahead of other processor tasks (28). Task-waiting thread 2 is assigned the second hardware acceleration task S4 and processes the second hardware acceleration task S4.

Since the second hardware acceleration task S3 performed by thread 4 is completed and no second hardware acceleration task is left in the second strand task queue, the V2X message processing device inputs the second processor task S3 into the task queue of the thread pool (29). Task-waiting thread 3 is assigned the second processor task S3 and processes the second processor task S3.

When the first processor tasks R6, R7, and R8 performed by each of thread 2, thread 3, and thread 4 are completed, the V2X message processing device sequentially inputs the first hardware acceleration tasks R6, R7, and R8 into the first strand task queue (30, 31, and 32).

When the first hardware acceleration task R5 performed by thread 1 is completed, the V2X message processing device inputs the first hardware acceleration task R6, which has been input into the first strand task queue, into the task queue of the thread pool ahead of other processor tasks (33). Task-waiting thread 4 is assigned the first hardware acceleration task R6 and processes the first hardware acceleration task R6.

When the first hardware acceleration task R6 performed by thread 4 is completed, the V2X message processing device inputs the first hardware acceleration task R7, which has been input into the first strand task queue, into the task queue of the thread pool ahead of other processor tasks (34). Task-waiting thread 4 is assigned the first hardware acceleration task R7 and processes the first hardware acceleration task R7.

When the second hardware acceleration task S4 performed by thread 4 is completed, no second hardware acceleration task is left in the second strand task queue, and thus the V2X message processing device inputs the second processor task S4 into the task queue of the thread pool (35). Task-waiting thread 2 is assigned the second processor task S4 and processes the second processor task S4.

When the first hardware acceleration task R7 performed by thread 4 is completed, the V2X message processing device inputs the first hardware acceleration task R8, which has been input into the first strand task queue, into the task queue of the thread pool ahead of other processor tasks (36). Task-waiting thread 4 is assigned the first hardware acceleration task R8 and processes the first hardware acceleration task R8.

As shown in FIG. 2, the first hardware acceleration tasks R1 to R8 are executed by multiple threads not simultaneously but in sequence, and the second hardware acceleration tasks S1 to S4 are likewise executed not simultaneously but in sequence.

A processor of the V2X message processing device according to the aspect of the present invention may be a multi-core processor, and the thread pool manager 110 may generate a number of threads equal to the number of cores of the processor included in the device 10 and manage the threads as a thread pool.

The multi-core processor can simultaneously execute as many processes as cores without context switching, and thus may be considered to be a number of processors corresponding to the number of cores.

When a number of threads equal to the number of processors are generated and processed in parallel, it is possible to minimize the occurrence of context switching between threads. Accordingly, the V2X message processing device 10 may generate a number of threads equal to the number of cores of the processor included therein and manage the threads as a thread pool.

The example of FIG. 2 is regarding a case of four processors, two processors with two cores, or a single processor with four cores, in which four threads are generated and used.

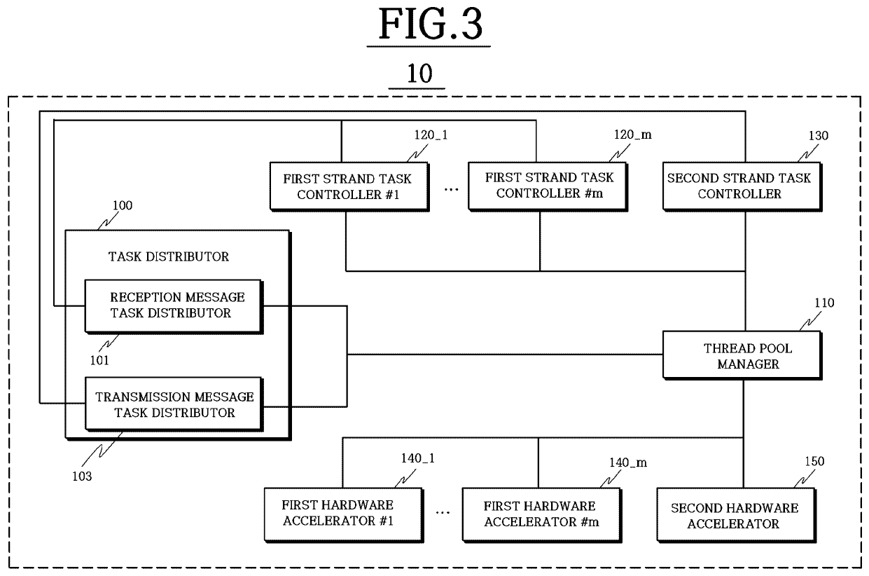

FIG. 3 is a block diagram of a device for processing V2X messages according to another aspect of the present invention. A V2X message processing device 10 according to the other aspect of the present invention may include m first hardware accelerators 140_1, . . . , and 140_m (m is a natural number of 2 or more) and accordingly include m first strand task controllers 120_1, . . . , and 120_m each mapped to a corresponding one of the first hardware accelerators 140_1, . . . , and 140_m.

Due to the nature of V2X service scenarios, incoming V2X messages far outnumber outgoing V2X messages, and V2X messages have no problem in encryption key management. Accordingly, a plurality of first hardware accelerators (first hardware accelerators #1 to #m) for accelerating ECDSA signature verification cryptography computation may be included to improve message processing performance. In this case, to prevent blockage of threads, first strand task controllers (first strand task controllers #1 to #m) may also be allocated to the first hardware accelerators on a one-to-one basis.

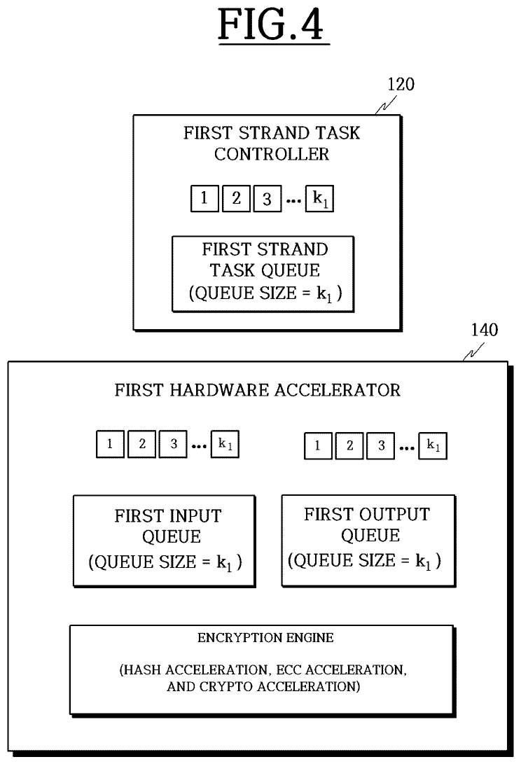

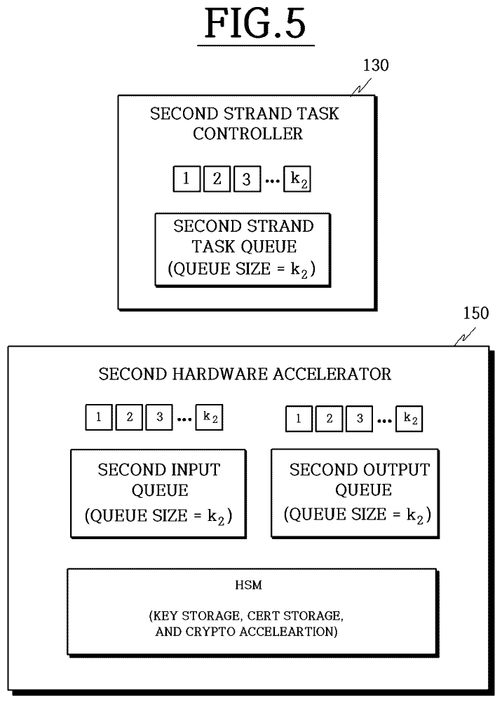

FIGS. 4 and 5 show examples of queue sizes of a strand task queue and an input queue and an output queue of a hardware accelerator.

In the V2X message processing device 10, for performance improvement, a first strand task queue and a first input queue and a first output queue of a first hardware accelerator may have the same size. In the example shown in FIG. 4, the first strand task queue and the first input queue and the first output queue of the first hardware accelerator all have the same size of k₁.

In addition, in the V2X message processing device 10, for performance improvement, a second strand task queue may have the same size as a second input queue and a second output queue of a second hardware accelerator. In the example shown in FIG. 5, the second strand task queue, and the second input queue and second output queue of the second hardware accelerator all have the same size of k₂.

According to the present invention, a function that is used for processing a V2X message through multiple threads and requires hardware-dedicated acceleration is serialized and processed in strands. Accordingly, only one thread is blocked by a hardware-dedicated acceleration chip, and other threads process other tasks in parallel such that the idle time of a processor can be minimized.

Although the present invention has been described through exemplary embodiments with reference to the accompanying drawings, the present invention is not limited thereto and should be construed to encompass various modified examples that can be apparently derived from the embodiments by those of ordinary skill in the art. The claims are intended to encompass these modified examples.

What is claimed is:

1. A device for processing a vehicle-to-everything (V2X) message including at least one processor, the device comprising:
a first hardware accelerator configured to sequentially perform first hardware acceleration tasks which are input into a first input queue and output task results to a first output queue;
a thread pool manager configured to manage n generated threads as a thread pool and assign tasks in a task queue to task-waiting threads to execute the threads in parallel;
a first strand task controller configured to request task processing from the thread pool manager such that first hardware acceleration tasks which are input into a first strand task queue are executed not simultaneously but in sequence; and
a task distributor including a reception message task distributor configured to split a V2X message processing task into a first processor task and a first hardware acceleration task, input the first processor task into the task queue of the thread pool manager, and input the first hardware acceleration task split from the same V2X message processing task into the first strand task queue when the first processor task is completed.

2. The device of claim 1, further comprising:
a second hardware accelerator configured to sequentially execute second hardware acceleration tasks input into a second input queue and outputs task results to a second output queue; and
a second strand task controller configured to request task processing from the thread pool manager such that the second hardware acceleration tasks input into a second strand task queue may be executed not simultaneously but in sequence,
wherein the task distributor further includes a transmission message task distributor configured to split a V2X message generation task into a second hardware acceleration task and a second processor task, input the second hardware acceleration task into the second strand task queue, and input the second processor task split from the same V2X message generation task into the task queue of the thread pool manager when the second hardware acceleration task is completed.

3. The device of claim 1, wherein the processor of the device is a multi-core processor, and
the thread pool manager generates a number of threads equal to a number of cores of the processor included in the device and manages the threads as the thread pool.

4. The device of claim 1, wherein m first hardware accelerators are provided, and
m first strand task controllers are provided and each mapped to a corresponding one of the first hardware accelerators.

5. The device of claim 1, wherein the first strand task queue has the same size as the first input queue and the first output queue of the first hardware accelerator.

6. The device of claim 2, wherein the second strand task queue has the same size as the second input queue and the second output queue of the second hardware accelerator.

7. The device of claim 4, wherein the first strand task queue has the same size as the first input queue and the first output queue of the first hardware accelerator.
